(19) United States
(12) Patent Application Publication
(10) Pub. No.: US 2008/0030502 A1
(43) Pub. Date: Feb. 7, 2008

(54) Diacritics positioning system for digital typography

(75) Inventor: Christopher J. Chapman, Framingham, MA (US)

Correspondence Address: BREINER & BREINER, L.L.C., P.O. BOX 320160, ALEXANDRIA, VA, 22320-0160, US

(73) Assignee: Monotype Imaging, Inc., Woburn, MA (US)

(21) Appl. No.: 11/498,724

(22) Filed: Aug. 4, 2006

(51) Int. Cl. G09G 5/26

(52) U.S. Cl. 345/472.3

(57) ABSTRACT

A diacritic positioning system employs a diacritic glyph's bounding box and the base glyph's bounding box, in combination with diacritic position data stored in the diacritic positioning system, to properly position one or more diacritics relative to the base glyph. The position data enables the diacritic positioning system to call associated functions that place multiple diacritics above and/or below a single base character without interfering with one another, e.g. to stack the diacritics. In addition, the information about the diacritic characters can be employed to prevent interference between a diacritic and the base character in special circumstances.

### FIELD OF THE INVENTION

This disclosure relates to the field of digital typography, and more particularly to the placement of diacritic glyphs relative to a base glyph being modified.

### BACKGROUND OF THE INVENTION

Various types of application programs, such as word processing and desktop publishing programs, provide the ability to influence the layout of textual and symbolic characters on a page. Initially, the character fonts that were available for use in these types of programs had a set of rules that defined their shapes and positioning. As new fonts have been developed, the technology pertaining to the appearance and layout of characters has also evolved, with new capabilities being added to the fonts. As a result, it is now possible to control a number of different parameters which determine the appearance and layout of characters in a line of text. Examples of these parameters include the identification of the specific glyphs that define the appearances of the characters, the positioning of the glyphs relative to one another, hanging punctuation, and optical alignment of a line of characters.

To provide these types of capabilities, a given font is comprised of more than just the glyphs that determine the appearances of the individual characters. A font definition consists of a number of data tables that relate to various parameters that control the implementation of the font. For instance, a TrueType font comprises a file that may contain up to 30 or more tables that determine the layout and other characteristics of the font. Examples of the types of data in these tables include kerning, i.e. spacing between characters, the metrics or dimensions of glyphs, variable properties such as line widths, and the like. The information provided by some of these tables is employed by a layout engine, which arranges the glyphs relative to one another for display or printing purposes. One example of a layout engine is the WorldType Layout Engine provided by Monotype Imaging Inc.

Different fonts contain different amounts of glyph positioning data that is available for use by the layout engine. In the context of the present invention, fonts can be divided into three categories that are based upon the amount of glyph positioning data that they contain. One category of fonts contains no positioning data, as might be found in bitmap fonts. A second category of fonts contains simple positioning data. An example of this type of font is the TrueType fonts, noted previously. A third category of fonts contains complex positioning data, such as OpenType fonts having GPOS tables.

Among other uses, the glyph positioning data contained in a font is employed to position glyphs for diacritical marks relative to the base glyph which they modify. There is a wide range of schemes that are used to encode simple positioning data for diacritic glyphs in various fonts. For example, a diacritic glyph may have an advance width that could be zero or positive. In addition, it could have a left side bearing that can be negative, to center it over a previous glyph, zero to center it over another glyph's origin, or positive.

One particular situation of interest occurs when combinations of diacritics are involved in the presentation of a typographical character. An example of a situation that could occur is illustrated in FIGS. 1A and 1B. FIG. 1A illustrates a base glyph for the Roman character “x”, and two diacritics, namely the diaeresis and macron. Both diacritics may have been designed at the same height, as illustrated in FIG. 1. Consequently, if both diacritics are displayed over the base character at their designed heights, they will interfere with one another, as illustrated in FIG. 1B. Other examples of issues associated with combinations of diacritics are discussed hereinafter in connection with disclosed embodiments of the invention.

Fonts which include complex positioning data, such as OpenType fonts with GPOS tables, may provide the layout engine with sufficient information to avoid the type of situation illustrated in FIG. 1B. However, when the layout engine encounters a font in either of the other two categories, i.e. no positioning data or simple positioning data, it may not be able to correct the result shown in FIG. 1B. The present invention avoids this type of result, by providing a diacritics positioning system, which can be incorporated within the layout engine itself, to properly position diacritics in fonts that do not contain complex positioning data.

### BRIEF STATEMENT OF THE INVENTION

To properly position one or more diacritics relative to a base glyph, the diacritic positioning system employs the diacritic glyph's bounding box and the base glyph's bounding box, in combination with diacritic position data stored in the diacritic positioning system. This information is employed to determine where to position each diacritic glyph, relative to the base glyph. The position data can be associated directly with the glyph's character code, e.g. a Unicode character code, or with the class to which it belongs, such as a Unicode combining class. This information enables the diacritic positioning system to call associated functions that stack multiple diacritics above and/or below a single base character without interfering with one another. In addition, the information about the diacritic characters can be employed to prevent interference between a diacritic and the base character in special circumstances.

The foregoing features of the diacritics positioning system, and the advantages achieved thereby, are explained hereinafter with reference to particular embodiments of the system, and examples of its application, illustrated in the accompanying drawings.

### BRIEF DESCRIPTION OF THE DRAWINGS

FIGS. 1A and 1B illustrate an example of two diacritics positioned over a base glyph;

FIG. 2 is a block diagram of the software components involved in the display of characters and other symbols of a font;

FIG. 3 is a more detailed illustration of the components of a font subsystem;

FIG. 4 is an illustration of the bounding boxes for the glyphs depicted in FIG. 1A;

FIG. 5 is a block diagram of an exemplary data structure for storing the mark orientations and association with positioning functions;

FIGS. 6A and 6B illustrate the positioning of two diacritics by the diacritics positioning system;

FIGS. 7A-7C illustrate an example of positioning diacritics for a Thai character;

FIGS. 8A and 8B illustrate an example of positioning diacritics in conjunction with a special base character; and

FIG. 9 is a flowchart illustrating the operation of the diacritics positioning system.

### DETAILED DESCRIPTION

The present invention is broadly directed to the generation of character images in a computer, for display on a display device, such as a monitor, and/or printing in a document. As background to the concepts which underlie the invention, a process for the generation and laying out of images of characters and symbols will first be described.

The general architecture of software programs that are loaded into and executed on a computer is illustrated in the block diagram of FIG. 2. In a typical situation, the user interacts with one or more application programs 10, such as a word processing program, a desktop publishing program, or a graphics program. In operation, as the user types words via the keyboard 12, the application program issues requests to the computer's operating system 14 to have the characters corresponding to the keystrokes drawn on the display 16. Similarly, when the user enters a command to print a document, the application program issues requests to the operating system which cause the corresponding characters to be printed via a printer (not shown). For illustrative purposes, the following description of embodiments of the invention will be provided for the example in which characters are drawn on the screen of the display 16 in response to user-entered keystrokes. It will be appreciated, however, that similar operations are carried out in connection with the printing of characters in a document on a printer.

When a user types a character via the keyboard 12, an indication of that event is provided to the application program 10 by the computer's operating system 14. In response, the application program issues a call to the computer's imaging system 18, to draw the character corresponding to the keystroke at a particular location on the display. That call includes a character code that designates a particular letter or other item of text, and style information which contains an identification of the font for the corresponding character. The imaging system 18 can be a component of the computer's operating system 14. Upon receipt of the request for a character in a particular font, the imaging system accesses a glyph cache 20, which contains bitmap images of characters. If the requested character has been previously displayed in the designated style, its image will be stored in the glyph cache, and immediately provided to the imaging system. If, however, the requested character is not stored in the cache, a call is made to a font subsystem 22, to obtain the requested image. The call to the font subsystem identifies a particular font object, a point size, a resolution and any possible variations.

The structure of the font subsystem is illustrated in FIG. 3. Within the font subsystem 22, the management of requested font objects is handled by a font server 24. In general, when a request for a font is received from an application program, for instance via the imaging system 18, the font server is responsible for locating the font or, if it is not available, the best substitute for it. The font server also retrieves the fonts that have been requested, and supplies them to the imaging system. The font server may also be responsible for displaying a font selection dialog box from which the user can choose a desired font, and/or providing a list of available fonts to the application program, to be displayed in a font menu.

Each font that is stored in the computer, for example on a hard disk, resides in a file. FIG. 3 illustrates a number of font files 26 that respectively store fonts labeled a through f. Each font file contains all of the data tables and other associated information that forms the definition of a font.

Fonts can be classified according to different technologies. Two well-known and widely used font technologies are TrueType and OpenType. These types of fonts are known as outline fonts, since their typeface designs, or glyphs, are specified by vectors which define the outlines of their shapes. Other types of fonts might fall into a category that is referred to as bit-mapped, or screen fonts, in which each pixel of a glyph is defined. Each of these technologies has a different set of rules for processing font data to satisfy a particular request. For instance, the characters of a bit-mapped font may be stored on the computer for a particular point size, e.g., 12 point. If the user requests the characters to be displayed at a different size, the pixel data must be processed to rescale the images of the characters. This processing is carried out in a font scaler 28a. In general, the font scaler operates in accordance with a set of rules for interpreting and processing the stored font data so as to satisfy specific requests from the font server 24. Each different type of font technology has an associated scaler for processing the data of fonts which conform to that technology. Thus, in the example of FIG. 3, a TrueType scaler 28b and a OpenType scaler 28c are contained within the font subsystem.

In operation, the application program 10 issues a request for a particular font object. The font object provides an identification of a glyph family, e.g. a particular character such as “lowercase a”, as well as its desired line weight and/or other parameters. The request from the application program also identifies any style variations to be applied to the character, such as italic, bold, underline, superscript, and the like. Upon receiving the font object, the font server 24 determines the font technology with which that object is associated, and passes the request on to the appropriate scaler 28. The scaler retrieves the necessary data from the font file 26 associated with the identified font, and processes it to meet the parameters specified in the request. The scaler then returns a glyph image to the font server 24, which is provided to the imaging system 18 and stored in the glyph cache 20.

As the individual glyph images are received from the font subsystem 22, they are displayed as a line of characters by the imaging system 18. The imaging system may include a layout engine 30, which adjusts the positions of individual glyphs relative to one another, and performs further modifications of the glyphs, to lay out a complete line of characters. In general, the layout engine receives an input string consisting of a sequence of character codes and associated style information. As a first step, the character codes are mapped to glyph codes specific to the font. This mapping is performed in accordance with a data table stored in the font file. The layout engine examines the glyph codes relative to certain rules and conditions, and selectively performs various operations on the glyphs. After these processes have been applied to the glyphs in a line, an output string is produced which contains bit-mapped information for drawing the appropriate glyph images.

One of the processes performed by the layout engine is to determine whether the positions of any of the glyphs should be adjusted, relative to one another. For instance, in the case of the word ‘To’, it may be desirable to shift the position of the glyph for the letter ‘o’ to the left, to avoid the appearance of a large space between the two letters. Another example, discussed in detail hereinafter, is to adjust the position of diacritic glyphs relative to the base glyphs that they modify.

Each of the processes performed by the layout engine relies upon the data contained in one or more font tables to carry out the appropriate adjustments to a sequence of glyphs. For instance, during the positioning procedure, the layout processor may refer to tables that contain data relating to kerning, baseline alignment and glyph properties. The font objects associated with the glyphs in a line are employed to select the appropriate tables from the various font files 26. After the glyphs in a line have been appropriately processed through the layout procedure, an output string of pixel values is produced, to control the display of the line of characters on the display device 16.

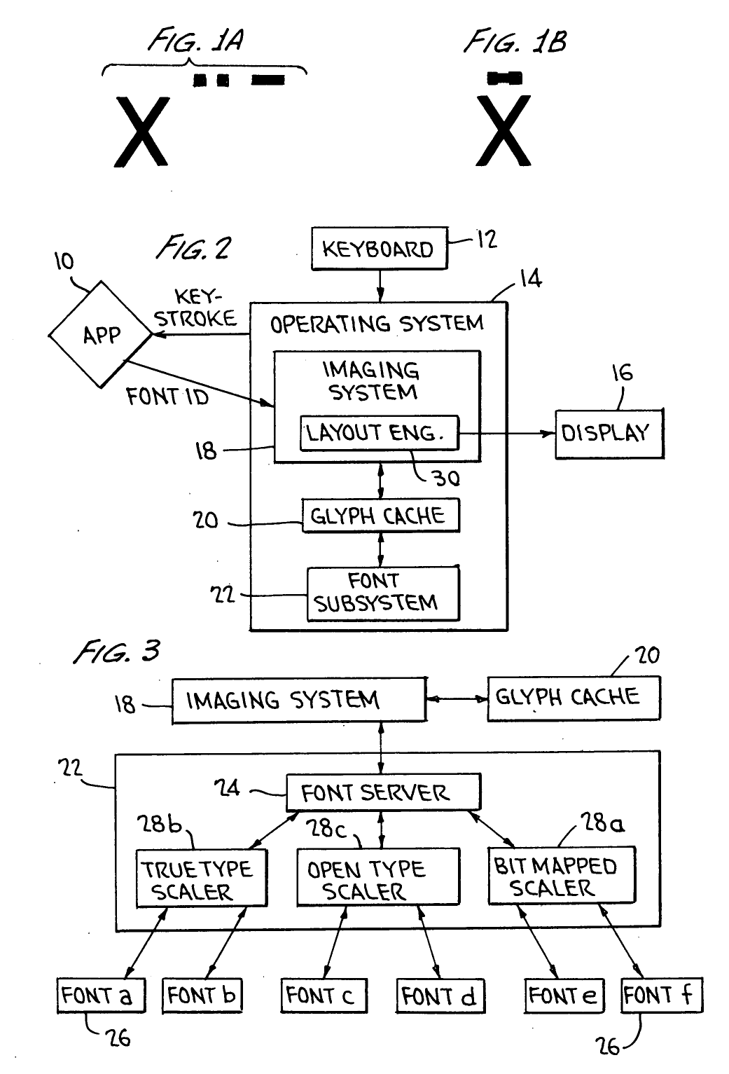

Turning now to the positioning of diacritics, it may be the case that one or more of the fonts that are employed in a document does not include all of the tables that are necessary for the layout processor to position diacritic glyphs in a manner that would avoid the type of result illustrated in FIG. 1B. As described previously, this is likely to occur in the case of fonts that have no positioning data, or only simple positioning data. In accordance with the present invention, this limitation is addressed by including a diacritics positioning system within the imaging system, which is separate from the font data contained in the font files 26. Preferably, the diacritic positioning system is incorporated within the layout engine 30.

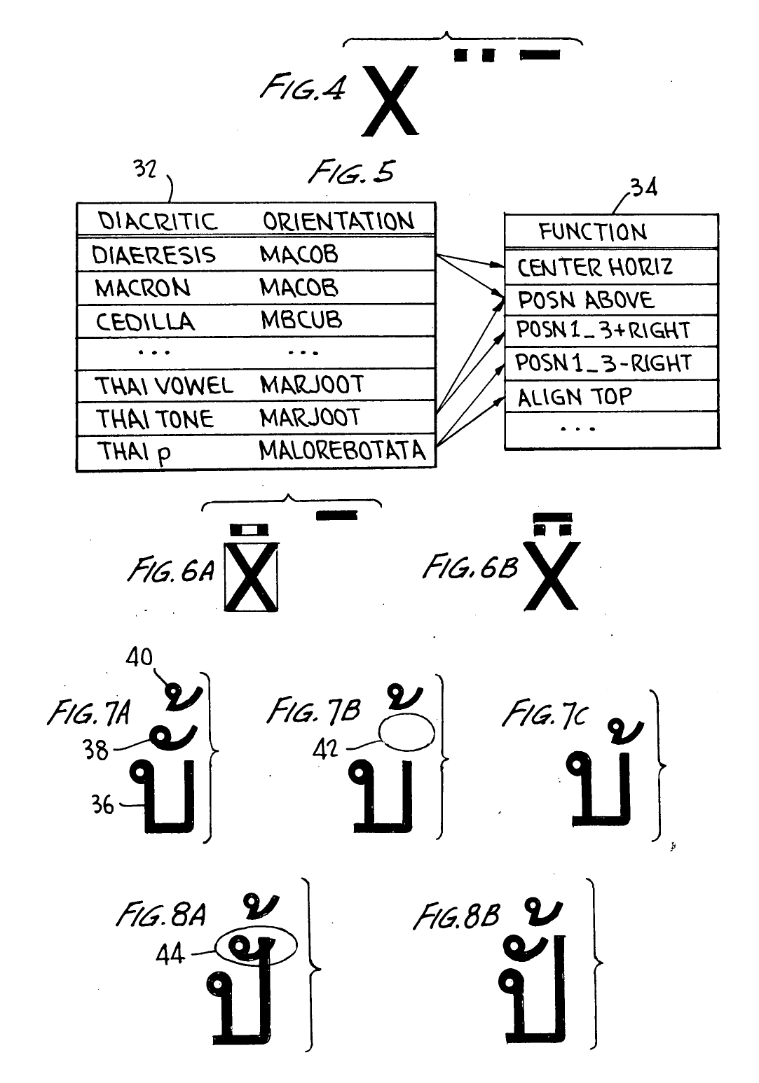

In operation, the diacritic positioning system employs three items of data to determine where to position a diacritic, namely (1) the base glyph's bounding box, (2) the diacritic glyph's bounding box, and (3) diacritic position data. The bounding boxes for the base glyph and the diacritic glyph are stored in the file 26 for the font. In general, the bounding box is a rectangle that defines the outer edges of the optical image of the glyph. Typically, the bounding box is defined in terms of the top, bottom, left side and right side optical bounds of the glyph. FIG. 4 illustrates examples of the glyphs shown in FIG. 1A, with their bounding boxes.

The third data item, the diacritic position data, is contained within the diacritic positioning system as mark orientation data that is separate from the font itself. Following are examples of mark orientations that can be stored in the diacritic positioning system:

```
    MARK ABOVE CENTERED OVER BASE
    MARK ABOVE CENTERED OVER BASE ATTACHED
    MARK ABOVE CENTERED OVER BASE ALIGNED
    AND TOP ALIGNED
    MARK ABOVE LEFT OF RIGHT EDGE BY ONE
    THIRD AND TOP ALIGNED
    MARK ABOVE LEFT OF RIGHT EDGE BY ONE
    THIRD AND ONE THIRD ABOVE
EDGE
    MARK ABOVE ALIGNED WITH RIGHT OF HIGHEST MARK
    MARK ABOVE LEFT ALIGNED
    MARK ABOVE RIGHT ALIGNED
    MARK ABOVE RIGHT ATTACHED
    MARK ABOVE CENTERED OVER RIGHT EDGE
    MARK ABOVE RIGHT JUTTING OUT ONE THIRD
    MARK ABOVE NO HORIZONTAL ALIGNMENT
    MARK ABOVE LEFT OF RIGHT EDGE BY
    ONE THIRD ATTACHED
    MARK BELOW CENTERED UNDER BASE
    MARK BELOW CENTERED UNDER BASE ATTACHED
    MARK BELOW LEFT ALIGNED
    MARK BELOW RIGHT ALIGNED
    MARK BELOW RIGHT ALIGNED ATTACHED
    MARK CENTERED
    MARK HORIZONTALLY CENTERED
    MARK LEFT
    MARK RIGHT
```

Each diacritic in a character set, e.g. the Unicode character set, has one of these mark orientations associated with it in the diacritic positioning system. Referring to FIG. 5, the diacritics positioning system might include a table 32 that is stored in memory, such as memory allocated to the layout engine 30. This table identifies the mark orientation associated with each diacritical mark. For ease of understanding, the table of FIG. 5 lists each diacritic by its name, but in practice the diacritical marks might be identified by their ASCII or Unicode value, or their Unicode combining class. Based on the mark orientation for a diacritic that has been requested, the diacritic positioning system calls a pair of functions 34 that are referenced by that mark orientation, to calculate the horizontal and vertical position of the diacritic glyph relative to the glyph of the base character. This positioning takes into account any other diacritics that have already been placed in conjunction with the base glyph. Each function comprises a set of instructions that are executable by the layout engine to perform a particular type of positioning of the diacritic glyph relative to the base glyph or a previously-positioned diacritic glyph. These sets of instructions might be stored, for example, in program memory for the layout engine.

An illustration of the operation of the diacritics positioning system will be provided with reference to the example depicted in FIG. 1A, where a diaeresis and a macron are to be positioned over the base character “x”. When the imaging system receives a call for the diaeresis, it looks up the mark orientation for the diaeresis in the table 32. In this case, the mark orientation is MARK ABOVE CENTERED OVER BASE (abbreviated as “MACOB” in FIG. 5). This mark orientation references two of the functions 34, namely “centerMarkHorizontally” and “positionMarkAboveHighestMark”. The function “centerMarkHorizontally” determines the horizontal center of the bounding boxes for each of the base glyph and the diacritic glyph, and aligns them. The function “positionMarkAboveHighestMark” determines the height of the diacritic glyph's bounding box, and positions the glyph above the bounding box of the base glyph by a defined amount, e.g. ⅓ the height of the diacritic glyph's bounding box. FIG. 6A illustrates the relative positions of the glyphs after these functions have been called.

Thereafter, the glyph for the macron is processed in a similar manner by the layout engine. First, the diacritics positioning system looks up the mark orientation for the macron, which is also MARK ABOVE CENTERED OVER BASE. Therefore, the same two functions are called. When the function “positionMarkAboveHighestMark” is called, the diacritics positioning system is aware that the diaeresis has already been placed above the base glyph. Consequently, it determines the vertical position of the macron glyph to be at the determined height above the glyph for the diaeresis. FIG. 6B illustrates the final result of the operation. As can be seen, the diaeresis and the macron are stacked over the glyph for the base character “x”. This result is achieved regardless of the left side bearing, advance width or height of the diaeresis and macron.

A different, but related, problem occurs with Thai fonts. The diacritics that appear above the base character are intentionally designed at two different levels. In FIG. 7A, the Thai character 36 for the consonant “b” is shown with a vowel mark 38 directly above it, and a tone mark 40 above the vowel mark. The vowel mark is designed for the lower level, as depicted, and the tone mark is designed to be drawn at the higher level. In some cases, the base character appears with only the tone mark, as shown in FIG. 7B. From an aesthetic standpoint, there is too much vertical space between the base character and the tone mark when this occurs, as demonstrated by the oval 42.

When this type of character is processed by the diacritics positioning system, it looks up the tone mark in the table 32, and determines that it has the mark orientation of MARK ABOVE RIGHT JUTTING OUT ONE THIRD. This orientation references the functions “positionMarkOneThirdPastRightEdge” and “positionMarkAboveHighestMark”. The function “positionMarkOneThirdPastRightEdge” sets the horizontal position of the diacritic's bounding box such that ⅓ of its width extends beyond the right edge of the base character's bounding box. The function “positionMarkAboveHighestMark” operates as described previously, to space the diacritic's glyph ⅓ of the height of its bounding box, for example, above the top edge of the base character's bounding box. The results of these operations are more aesthetically pleasing, as shown in FIG. 7C.

Another situation that can arise with Thai fonts, where the diacritics are designed at fixed heights, is the possibility that a diacritic can overlap a “tall” base character. An example of this situation is illustrated in FIG. 8A, which shows the Thai character for the consonant “p” with a vowel mark and a tone mark above it. In this example, the vowel mark overlaps the taller right stroke of the base character, as shown within the oval 44.

To accommodate this type of situation in the diacritics positioning system, base characters having special characteristics can also be listed in the table 32, with associated mark orientations to be applied to any diacritics that modify them. In this example, the Thai character for the consonant “p” is listed in the table with the associated mark orientation MARK ABOVE LEFT OF RIGHT EDGE BY ONE THIRD AND TOP ALIGNED. When the diacritics positioning system receives a request to draw a diacritic glyph, it checks the table 32 to see if the base character is listed as a special character. If so, it substitutes the mark orientation associated with the special character for the mark orientation normally associated with the diacritic, and calls the functions referenced by the replacement mark orientation. Thus, when positioning the diacritic at the lower level, i.e., the vowel mark, the diacritics positioning system calls the functions “positionMarkLeftOfRightEdgeByOneThird” and “alignMarkWithTopEdge”, that are associated with the substituted mark orientation. The function “positionMarkLeftOfRightEdgeByOneThird” sets the horizontal position of the vowel mark to the left of the right edge of the base glyph's bounding box by ⅓ of the width of the vowel mark's bounding box. The function “alignMarkWithTopEdge” sets the vertical position of the vowel mark so that the upper edge of its bounding box has the same vertical coordinate as the upper edge of the base glyph's bounding box.

For a diacritic at the higher level, overlap with a tall character does not occur. Thus, to draw the tone mark, the diacritics positioning system employs its original mark orientation, i.e., MARK ABOVE RIGHT JUTTING OUT ONE THIRD, and the functions referenced by it. The positioning of the tone mark is carried out relative to the lower vowel mark, rather than the base character. The result is shown in FIG. 8B. As can be seen, both the vowel mark and the tone mark have vertical and horizontal positions that are more aesthetically pleasing. In the system when positioning the vowel mark with respect to the base character, the first diacritic following the special case base character gets the special case handling. To ensure that diacritics are in a correct order for vertical stacking (e.g. Thai vowel mark before Thai tone mark, Arabic shadda before Arabic damma), the diacritics are reordered based on script-specific diacritics classes (e.g. Thai diacritics have one ordered set of classes, Arabic diacritics have another ordered set of classes). Diacritics within the same class maintain their original order, diacritics of different classes are sorted based on the order of their respective classes.

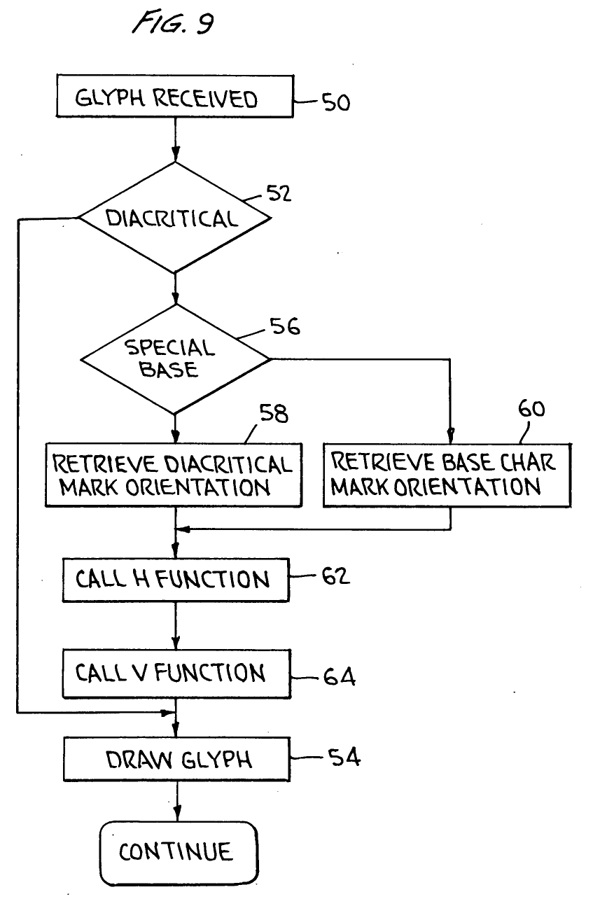

The operation of the diacritics positioning system, to achieve the foregoing results, is depicted in the flow chart of FIG. 9. At step 50, the layout engine receives data for a glyph to be drawn. Upon receiving the glyph data, a determination is made at step 52 whether the glyph is a diacritic glyph. If not, the layout engine continues with its normal processing to draw the glyph, at step 54. If the glyph to be drawn is a diacritic glyph, a further determination is made at step 56 whether the glyph is to be drawn in conjunction with a special base character, e.g. a “tall” character. This determination is made by detecting whether the base character has a corresponding entry in the table 32. If the base character is not a special character, the mark orientation for the diacritic is retrieved from the table 32, at step 58. On the other hand, if the base character is a special character, the mark orientation associated with that base character is retrieved from the table, at step 60.

Once the appropriate mark orientation has been retrieved, a call is made to the referenced function for determining the horizontal position of the diacritic glyph, at step 62. Thereafter, at step 64, a call is made to the associated function for determining the height of the glyph. It will be appreciated that steps 62 and 64 can be performed in the reverse order. Once the appropriate horizontal and vertical positions have been determined, the diacritic glyph is drawn at those positions, at step 54. The layout engine then continues with the process for drawing the next glyph in the line.

From the foregoing, therefore, it can be seen that the diacritics positioning system of the present invention functions to properly position one or more diacritic glyphs relative to a base glyph. Since the mark orientation and positioning functions are associated with the diacritics positioning system, rather than an individual font, the diacritics positioning system is capable of properly positioning diacritic glyphs for fonts that do not contain complex positioning data. Furthermore, by including positioning information for special base characters, added capabilities are provided to obtain aesthetically pleasing appearances in the resulting characters.

It will be appreciated by those of ordinary skill in the art that the present invention can be embodied in other forms without departing from the spirit or essential characteristics thereof. The foregoing description is therefore considered to be illustrative, and not restrictive. The scope of the invention is indicated by the following claims, and all changes that come within the meaning and range of equivalents are therefore intended to be embraced therein.

What is claimed is:

1. A diacritic positioning system, comprising:
a memory having stored therein:
a plurality of sets of computer-executable instructions that function to position a diacritic glyph relative to another glyph; and
data that contains positioning information for each of a plurality of diacritics, said positioning information including a reference to at least one of said sets of instructions; and
a layout engine that, in response to a request to draw a diacritic glyph, retrieves the positioning information stored for the glyph requested and calls the set of instructions referenced by said positioning information, to determine a position for the glyph requested and draw the glyph at that determined position.

2. The diacritic positioning system of claim 1, wherein the positioning information for a diacritic references a first set of instructions for determining vertical position of a diacritic glyph relative to another glyph, and a second set of instructions for determining horizontal position of the diacritic glyph relative to another glyph.

3. The diacritic positioning system of claim 1, wherein in response to a request to draw a first diacritic, the layout engine positions said first diacritic relative to a base character modified by said diacritic and, in response to a request to draw a second diacritic that modifies said base character, the layout engine positions said second diacritic relative to said first diacritic.

4. The diacritic positioning system of claim 1, wherein said data further includes positioning information associated with predetermined base characters.

5. The diacritic positioning system of claim 4, wherein upon receiving a request to draw a diacritic glyph, said layout engine determines if said diacritic glyph is to be drawn in conjunction with one of said predetermined base characters and, if so, calls the set of instructions referenced by the positioning information stored for said predetermined base character.

6. The diacritic positioning system of claim 5, wherein said set of instructions referenced by the positioning information stored for said predetermined base character is called in place of the set of instructions referenced by the positioning information stored for said diacritic.

7. A method for drawing a diacritic glyph relative to another glyph, comprising:
storing, for each of a plurality of diacritic glyphs, positioning information associated with a corresponding diacritic that references at least one set of instructions that function to position a diacritic glyph relative to another glyph;
in response to a request to draw a given diacritic, retrieving the positioning information stored associated with said corresponding diacritic; and
calling the set of instructions referenced by the positioning information retrieved to determine a position for the corresponding diacritic glyph and draw the diacritic glyph at the determined position.

8. The method of claim 7, wherein the positioning information for a diacritic references a first set of instructions for determining vertical position of a diacritic glyph relative to another glyph, and a second set of instructions for determining horizontal position of the diacritic glyph relative to another glyph.

9. The method of claim 7, wherein in response to a request to draw a first diacritic, said first diacritic is positioned relative to a base character modified by said diacritic and, in response to a request to draw a second diacritic that modifies said base character, said second diacritic is positioned relative to said first diacritic.

10. The method of claim 7, wherein said data further includes positioning information associated with predetermined base characters.

11. The method of claim 10, further including steps of determining if said diacritic glyph is to be drawn in conjunction with one of said predetermined base characters and, if so, calling the set of instructions referenced by the positioning information stored for a predetermined base character.

12. The method of claim 11, wherein said set of instructions referenced by the positioning information stored for said predetermined base character is called in place of the set of instructions referenced by the positioning information stored for said diacritic.

13. A computer-readable medium containing:
a plurality of sets of instructions that function to position a diacritic glyph relative to another glyph;
data that contains positioning information for each of a plurality of diacritics, said positioning information including a reference to at least one of said sets of instructions; and
a program that, in response to a request to draw a diacritic glyph, retrieves the positioning information stored for the glyph requested and calls the set of instructions referenced by said positioning information, to determine a position for the glyph requested and draw the glyph at that determined position.

14. The computer-readable medium of claim 13, wherein the positioning information for a diacritic references a first set of instructions for determining vertical position of a diacritic glyph relative to another glyph, and a second set of instructions for determining horizontal position of the diacritic glyph relative to another glyph.

15. The computer-readable medium of claim 13, wherein in response to a request to draw a first diacritic, said program positions said first diacritic relative to a base character modified by said diacritic and, in response to a request to draw a second diacritic that modifies said base character, said program positions said second diacritic relative to said first diacritic.

16. The computer-readable medium of claim 13, wherein said data further includes positioning information associated with predetermined base characters.

17. The computer-readable medium of claim 16, wherein upon receiving a request to draw a diacritic glyph, said program determines if said diacritic glyph requested is to be drawn in conjunction with one of said predetermined base characters and, if so, calls the set of instructions referenced by the positioning information stored for said one of said predetermined base characters.

18. The computer-readable medium of claim 17, wherein said set of instructions referenced by the positioning information stored for said one of said predetermined base characters is called in place of the set of instructions referenced by the positioning information stored for said diacritic.
